(19) United States
(12) Patent Application Publication
(10) Pub. No.: US 2025/0052619 A1
(43) Pub. Date: Feb. 13, 2025

(54) METHOD AND DEVICE FOR MEASURING TEMPERATURE OF WIRE ROD, STORAGE MEDIUM, AND COMPUTER DEVICE

(71) Applicant: NORTHEASTERN UNIVERSITY, Shenyang (CN)

(72) Inventors: Guohui MEI, Shenyang (CN); Wu LV, Shenyang (CN); Shumao ZHAO, Shenyang (CN); Ying CI, Shenyang (CN); Jiu ZHANG, Shenyang (CN); Hong LIU, Shenyang (CN)

(73) Assignee: NORTHEASTERN UNIVERSITY, Shenyang (CN)

(21) Appl. No.: 18/928,766

(22) Filed: Oct. 28, 2024

Related U.S. Application Data
(63) Continuation of application No. PCT/CN2024/105712, filed on Jul. 16, 2024.

(30) Foreign Application Priority Data
Jul. 21, 2023 (CN) 202310905741.3

(51) Int. Cl. G01J 5/00; G01J 5/06

(52) U.S. Cl. CPC G01J 5/0096; G01J 5/0003; G01J 5/06; G01J 2005/0077

(57) ABSTRACT

A method and a device for measuring a temperature of a wire rod, a storage medium, and a computer device are disclosed. The method includes: determining an effective temperature measurement area according to the infrared thermal image and feature information of the wire rod; projecting preset light onto the wire rod geometric model, tracing a light propagation path of the preset light, and calculating an effective emissivity based on a tracing result of the light propagation path; and correcting temperature measurements in the effective temperature measurement area based on the effective emissivity to obtain a corrected temperature measurement result. The infrared thermal image is acquired, and is analyzed by image processing, thereby dynamically capturing the effective temperature measurement area. The effective emissivity between wire rods is calculated, and then the measured temperature of the wire rod is corrected, thereby improving the accuracy and stability of temperature measurement on wire rods.

### CROSS-REFERENCE TO RELATED APPLICATIONS

The application claims priority to Chinese patent application No. 202310905741.3, filed on Jul. 21, 2023, the entire contents of which are incorporated herein by reference.

### TECHNICAL FIELD

The present disclosure relates to the technical field of production of high-speed wire rods, and in particular to a method and a device for measuring a temperature of a wire rod, a storage medium, and a computer device.

### BACKGROUND

Stelmor controlled cooling is often employed to intelligently control temperatures of wire rods. The process layout of the Stelmor controlled cooling is as follows. A wire rod is conveyed in a water-cooling section composed of multiple water tanks for forced water cooling immediately after coming out of a finishing mill, and then is clamped by pinch rollers into a laying head for coiling, and is laid out in a loose roll on a continuously running Stelmor roller conveyor above which a fan is installed for blast cooling, and is finally conveyed to a collection drum for collection. Controlling the temperature of the rolled piece by the water-cooling section can prevent grain growth and prepare for subsequent phase transformation. The air-cooling section controls the phase transformation of the rolled piece at a certain cooling rate to obtain the desired structure. Mechanical properties and microstructure of the wire rod mainly depend on the phase change during air cooling, and therefore it is crucial to accurately control the cooling rate during the phase change. However, the existing temperature measurement is less accurate due to factors like harsh production conditions, geometric features of the wire rod, changes in target position for temperature measurement resulted from swing of the wire rod between left and right on the roller, and effective radiation generated by the overlap between wire rods.

On the Stelmor air-cooling line, there are currently two main approaches for measuring a temperature of the wire rod. One is to model and simulate the air-cooling process on the wire rod to predict the change in the temperature of the wire rod, and the other is to directly measure the temperature of the wire rod in a non-contact manner. In the first approach, the model parameters are set based on the temperature of the wire rod measured at the production site, and then the accuracy of the model is restricted by the accuracy of the measured temperature. In the second approach, most companies currently use fixed aligned pyrometers to measure the temperature of the wire rod, and a few companies use scanning pyrometers. Due to the influence of the mesh structure produced by the overlap between wire rods, it is difficult to accurately measure the temperature of the wire rod. The prerequisite for temperature measurement by the contact thermometer is that the object whose temperature is to be measured must be larger than the light spot of the contact thermometer in size, and the diameter of the wire rod approximately ranges from 5.5 to 20 mm. Therefore, in order to reliably measure the temperature of the wire rod, an area, which is basically not affected by holes formed by the overlap between wire rods, at a certain distance from the edge of the wire rod is usually selected as an effective temperature measurement area. For the fixed aligned pyrometer, the object whose temperature is to be measured should be stationary. However, the wire rod will move in the lateral direction during its forward conveying on the roller, and then it is difficult for the fixed aligned pyrometer to align with the object whose temperature is to be measured. The scanning pyrometer scans the effective temperature measurement area up and down and obtains the temperature information of the wire rod by peak filtering. The scanning pyrometer can capture the target measurement area, but may miss part of temperature information due to the influence of the scanning cycle. In addition, the scanning pyrometer fails to solve the instability and inaccuracy of the temperature measurement results caused by the effective radiation between wire rods.

### SUMMARY

In view of this, a method and a device for measuring a temperature of a wire rod, a storage medium, and a computer device are provided according to the present disclosure. An infrared thermal image is acquired, and is analyzed by image processing, thereby dynamically capturing an effective temperature measurement area. The effective emissivity between wire rods is calculated, and then the measured temperature of the wire rod is corrected, thereby improving the accuracy and stability of temperature measurement on wire rods.

According to one aspect of the present disclosure, a method for measuring a temperature of a wire rod is provided. The method includes:
acquiring, in real time, an infrared thermal image of the wire rod whose temperature is to be measured;
determining an effective temperature measurement area according to the infrared thermal image and feature information of the wire rod;
constructing a wire rod geometric model of the wire rod, projecting preset light onto the wire rod geometric model, tracing a light propagation path of the preset light, and calculating an effective emissivity based on a tracing result of the light propagation path; and
correcting temperature measurements in the effective temperature measurement area based on the effective emissivity to obtain a corrected temperature measurement results.

Optionally, the projecting preset light onto the wire rod geometric model, tracing a light propagation path of the preset light, and calculating an effective emissivity based on a tracing result of the light propagation path includes:
constructing multiple light rays to be traced, and projecting the light rays to be traced onto target projection points on the wire rod geometric model respectively, where the wire rod geometric model includes multiple target projection points;
tracing a light propagation path of a light ray that is being projected onto the wire rod geometric model, and determining whether the light ray to be traced is absorbed by the wire rod geometric model according to the light propagation path; and
calculating a local effective emissivity of a target projection point according to the number of absorbed light rays to be traced and the total number of light rays to be traced, and acquiring the effective emissivity for the wire rod geometric model according to the local effective emissivities for the multiple target projection points.

Optionally, before projecting the light rays to be traced onto the target projection points on the wire rod geometric model respectively, the method further comprises:
determining a projection angle of each light ray to be traced and an intrinsic emissivity of the wire rod.

Correspondingly, the projecting the light rays to be traced onto the target projection points on the wire rod geometric model respectively includes:
for a light ray to be traced, projecting the light ray to be traced onto the target projection point on the wire rod geometric model at such a projection angle that the light ray to be traced propagates toward the target projection point.

Optionally, the determining whether the light ray to be traced is absorbed by the wire rod geometric model according to the light propagation path includes:
generating a random number when the light ray to be traced is projected onto the target projection point of the wire rod geometric model;
determining that the light ray to be traced is reflected if the random number is greater than the intrinsic emissivity of the wire rod; and
determining that the light ray to be traced is absorbed if the random number is less than the intrinsic emissivity of the wire rod.

Optionally, correcting temperature measurements in the effective temperature measurement area based on the effective emissivity to obtain a corrected temperature measurement result includes:
filtering the temperature measurements in the effective temperature measurement area to obtain multiple peak temperatures after filtering; and
determining an effective peak emissivities within multiple change cycles according to a change cycle of the effective emissivity, calculating a peak temperature interference deviation based on differences between the effective peak emissivities and an intrinsic emissivity, and correcting the peak temperatures according to the peak temperature interference deviation to obtain the corrected temperature measurement result.

Optionally, the determining an effective temperature measurement area according to the infrared thermal image and feature information of the wire rod includes:
performing spatial transformation on the infrared thermal image according to a shooting angle of the infrared thermal image to obtain physical positions of all pixels in the infrared thermal image; and
determining a wire rod area based on the physical positions and the feature information of the wire rod, and determining the effective temperature measurement area based on the wire rod area and a preset deviation distance.

Optionally, the constructing a geometric model of the wire rod to be temperature measured includes:
acquiring geometric parameters of the wire rod to be temperature measured, where the wire rod geometric parameters include spatial coordinate parameters of the wire rod along an X-axis, a Y-axis and a Z-axis in a preset spatial coordinate system;
and constructing the wire rod geometric model in the preset spatial coordinate system based on the spatial coordinate parameters.

According to another aspect of the present disclosure, a device for measuring a temperature of a wire rod is provided. The device includes:
an infrared thermal image acquisition module for acquiring, in real time, an infrared thermal image of the wire rod whose temperature is to be measured;
an effective measurement area determination module for determining an effective temperature measurement area according to the infrared thermal image and feature information of the wire rod;
an effective emissivity calculation module for constructing a wire rod geometric model, projecting preset light onto the wire rod geometric model, tracing a light propagation path of the preset light, and calculating an effective emissivity based on a tracing result of the light propagation path; and
a temperature correction module for correcting temperature measurements in the effective temperature measurement area based on the effective emissivity to obtain a corrected temperature measurement result.

Optionally, the effective emissivity calculation module is further configured to: construct multiple light rays to be traced, and project the light rays to be traced onto target projection points on the wire rod geometric model respectively, where the wire rod geometric model includes multiple target projection points;
trace a light propagation path of the light ray that is being projected onto the wire rod geometric model, and determine whether the light ray to be traced is absorbed by the wire rod geometric model according to the light propagation path; and
calculate a local effective emissivity of a target projection point according to the number of absorbed light rays and the total number of light rays to be traced, and acquire the effective emissivity for the wire rod geometric model according to the local effective emissivities for the multiple target projection points.

Optionally, the effective emissivity calculation module is further configured to: determine a projection angle of each light ray to be traced and an intrinsic emissivity of the wire rod; and
for a light ray to be traced, project the light ray to be traced onto the target projection point on the wire rod geometric model at such a projection angle that the light ray to be traced propagates toward the target projection point.

Optionally, the effective emissivity calculation module is further configured to: generate a random number when the light ray to be traced is projected onto the target projection point of the wire rod geometric model;
determine that the light ray to be traced is reflected if the random number is greater than the intrinsic emissivity of the wire rod;
and determine that the light ray to be traced is absorbed if the random number is less than the intrinsic emissivity of the wire rod.

Optionally, the temperature correction module is further configured to: filter the temperature measurements in the effective temperature measurement area to obtain multiple peak temperatures after filtering;
and determine effective peak emissivities in multiple change cycles according to a change cycle of the effective emissivity, calculate a peak temperature interference deviation based on differences between the effective peak emissivities and the intrinsic emissivity, and correct the peak temperatures according to the peak temperature interference deviation to obtain the corrected temperature measurement result.

Optionally, the effective measurement area determination module is further configured to: perform spatial transformation on the infrared thermal image according to a shooting angle of the infrared thermal image to obtain physical positions of all pixels in the infrared thermal image;
and determine a wire rod area based on the physical positions and the feature information of the wire rod, and determine the effective temperature measurement area based on the wire rod area and a preset deviation distance.

Optionally, the geometric model construction module is further configured to: acquire geometric parameters of the wire rod to be temperature measured, where the wire rod geometric parameters include spatial coordinate parameters of the wire rod along an X-axis, a Y-axis and a Z-axis in a preset spatial coordinate system;
and construct the geometric model of the wire rod to be temperature measured in the preset spatial coordinate system based on the spatial coordinate parameters.

According to another aspect of the present disclosure, a storage medium on which a computer program is stored is provided. When the program is executed by a processor, the above method for measuring a temperature of a wire rod is implemented.

According to another aspect of the present disclosure, a computer device is provided. The computer device includes a storage medium, a processor, and a computer program which is stored on the storage medium and executable by the processor. When the processor executes the program, the above method for measuring a temperature of a wire rod is implemented.

With the above technical solutions, a method and a device for measuring a temperature of a wire rod, a storage medium, and a computer device are provided according to the present disclosure. An infrared thermal image of the wire rod whose temperature is to be measured is acquired in real time. According to the infrared thermal image and the feature information of the wire rod, an effective temperature measurement area is determined. A geometric model of the wire rod to be temperature measured is constructed, preset light is projected onto the wire rod geometric model, the light propagation path of the preset light is traced, and the effective emissivity is calculated based on the tracing result of the light propagation path. Based on the effective emissivity, the temperature measurements in the effective temperature measurement area are corrected to obtain a corrected temperature measurement result. The infrared thermal image is acquired, and is analyzed by image processing, thereby dynamically capturing the effective temperature measurement area. The effective emissivity between wire rods is calculated, and then the measured temperature of the wire rod is corrected, thereby improving the accuracy and stability of temperature measurement on wire rods.

The above summary is only an overview of the technical solutions of the present disclosure. In order to more clearly understand the technical means of the present disclosure so as to implement the technical solutions in accordance with the contents of the specification, and further in order to make the above and other purposes, features and advantages of the present disclosure more understandable, the specific embodiments of the present disclosure are listed below.

### BRIEF DESCRIPTION OF DRAWINGS

The drawings described herein are used to provide a further understanding of the present disclosure and constitute a part of the present disclosure. The illustrative embodiments of the present disclosure and their descriptions are used to explain the present disclosure instead of constituting an improper limitation on the present disclosure. In the drawings:

FIG. 1 shows a schematic flow chart of a method for measuring a temperature of a wire rod according to an embodiment of the present disclosure;

FIG. 2 shows a schematic diagram of a temperature measurement system according to an embodiment of the present disclosure;

FIG. 3 shows a schematic diagram of a wire rod according to an embodiment of the present disclosure;

FIG. 4 shows a schematic flow chart of a method for measuring a temperature of a wire rod according to another embodiment of the present disclosure;

FIG. 5 shows a wire rod geometric model according to an embodiment of the present disclosure;

FIG. 6 shows a schematic flow chart of a method for measuring a temperature of a wire rod according to another embodiment of the present disclosure;

FIG. 7 shows a schematic structural diagram of a device for measuring a temperature of a wire rod according to an embodiment of the present disclosure; and

FIG. 8 shows a schematic structural diagram of a device for measuring a temperature of a wire rod according to another embodiment of the present disclosure.

Reference numerals:

21 thermal imager; 22 field of view; 23 support frame;
24 first baffle; 25 roller; 26 wire rod; 27 second baffle.

### DETAILED DESCRIPTION OF THE EMBODIMENTS

The present disclosure will be described in detail below with reference to the drawings and in combination with the embodiments. It should be noted that the embodiments and features in the embodiments of the present disclosure can be combined with each other without conflict.

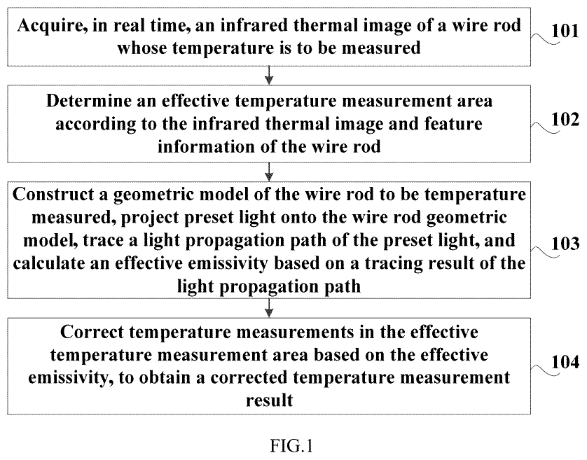

In this embodiment, a method for measuring a temperature of a wire rod is provided. As shown in FIG. 1, the method includes the following steps 101 to 104.

In step 101, an infrared thermal image of the wire rod whose temperature is to be measured is acquired in real time.

Stelmor controlled cooling is an intelligent temperature control method that can eliminate or reduce post-heat treatments in downstream processes such as quenching, annealing and quenching/tempering, thereby saving energy and the environment and improving the price competitiveness of the rolling mill. In addition, Stelmor Controlled Cooling employs a roller conveyor, a cooling fan under the conveyor and an insulating cover above the conveyor, and can produce a variety of products through only one cooling line.

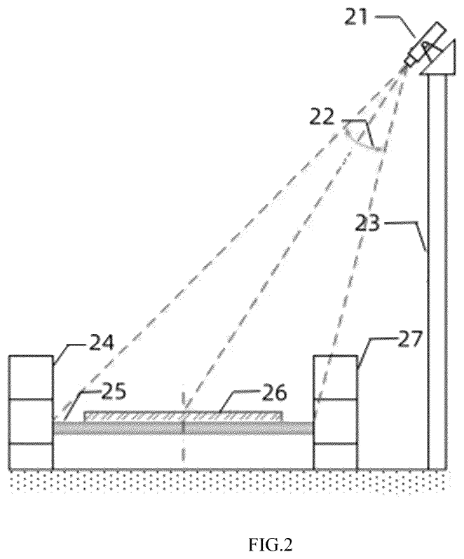

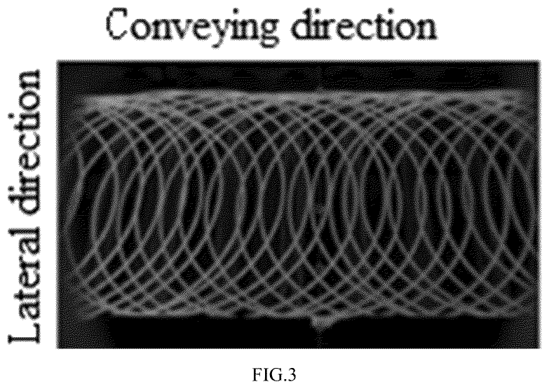

In the embodiment of the present disclosure, the temperature of the wire rod is measured during the air cooling of the Stelmor controlled cooling process. Specifically, the infrared thermal image of the wire rod whose temperature is to be measured is obtained in real time. The temperature of the wire rod may be measured by constructing a temperature measurement system. A thermal imager in the temperature measurement system obtains the infrared thermal image of the entire wire rod, thereby ensuring the integrity of the temperature measurement information. The installation requirements for the thermal imager are as follows. The thermal imager should cover the entire wire rod, and a spatial resolution of the thermal imager must be less than ⅓ of that of the wire rod to ensure the accuracy of temperature measurement, and the angle between the temperature measurement direction of all temperature measurement points and the normal direction of the wire rod surface is less than 45°. In addition, the thermal imager must be calibrated in order to be correctly used. The temperature measurement system is shown in FIG. 2, and the wire rod is shown in FIG. 3.

In step 102, an effective temperature measurement area is determined based on the infrared thermal image and feature information of the wire rod.

Next, the effective temperature measurement area is determined based on the infrared thermal image and the feature information of the wire rod. Since the effective temperature measurement area moves in the conveying direction and the lateral direction perpendicular to the roller during the actual production of the wire rod, fixed aligned pyrometers and the scanning pyrometers fail to capture the temperature information in the effective temperature measurement area in real time and completely. A target area is determined according to the difference in temperature feature between the wire rod and the surrounding environment, and then the temperature measurement area is extracted according to the target area. The effective temperature measurement area of the wire rod can be dynamically captured during the movement of the wire rod, thereby improving the accuracy of temperature measurement.

In step 103, a geometric model of the wire rod whose temperature is to be measured is constructed, preset light is projected onto the wire rod geometric model, a light propagation path of the preset light is traced, and an effective emissivity is calculated based on a tracing result of the light propagation path.

Next, a geometric model of the wire rod whose temperature is to be measured is constructed. For example, a geometric model of the object to be measured may be established based on a geometric shape, optical properties of the material, surface properties, and isothermal conditions of the cavity of the object (i.e., the wire rod). Since it is difficult to experimentally determine the effective emissivity, a model calculation method, e.g., the Monte Carlo method (MCM), is usually employed to calculate the effective emissivity of the wire rod. The Monte Carlo method is to calculate the effective emissivity of a point on an inner surface of the cavity according to the cavity geometry model. Therefore, preset light is projected onto the wire rod geometry model and a light propagation path of the preset light is traced, and then the effective emissivity is calculated based on the tracing result of the light propagation path.

In step 104, temperature measurements in the effective temperature measurement area are corrected based on the effective emissivity to obtain a corrected temperature measurement result.

Then, the temperature measurements in the effective temperature measurement area are corrected according to the effective emissivity, to obtain the corrected temperature measurement result. Due to the overlap between wire rods, the energy at one point of the wire rod includes not only the energy emitted by the wire rod itself at this point but also the energy reflected by other wire rods, that is, is affected by effective radiation. However, the inherent emissivity of the wire rod set by the thermal imager during actual temperature measurement process only considers the energy emitted by the wire rod itself, resulting in inaccuracy in the temperature measurement result. Establishing a calculation model of the effective emissivity to process the temperature measurement result of the thermal imager can improve the stability and accuracy of temperature measurement.

With the technical solution of this embodiment, the infrared thermal image of the wire rod whose temperature is to be measured is acquired in real time, and the effective temperature measurement area is determined according to the infrared thermal image and the feature information of the wire rod. A geometric model of the wire rod to be temperature measured is constructed, preset light is projected onto the wire rod geometric model and a light propagation path of the preset light is traced, and then the effective emissivity is calculated based on a tracing result of the light propagation path. Based on the effective emissivity, temperature measurements in the effective temperature measurement area are corrected to obtain the corrected temperature measurement result. The infrared thermal image is acquired, and is analyzed by image processing, thereby dynamically capturing the effective temperature measurement area. The effective emissivity between wire rods is calculated, and then the measured temperature of the wire rod is corrected, thereby improving the accuracy and stability of temperature measurement on wire rods.

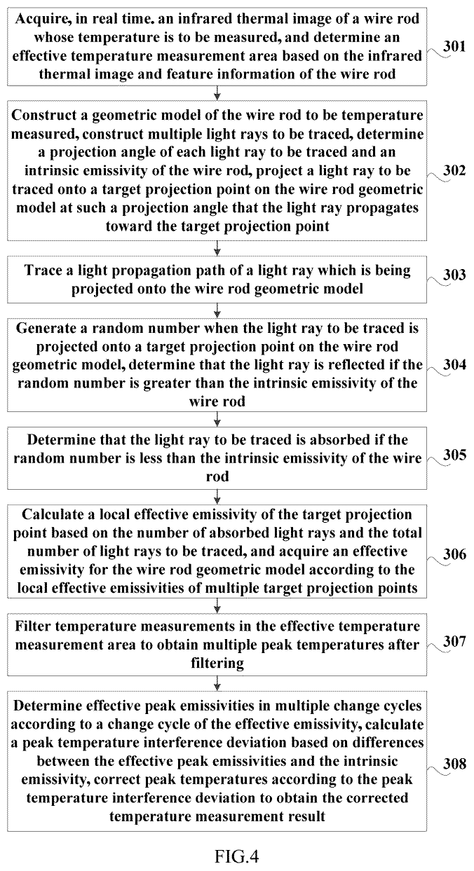

Furthermore, in order to fully illustrate the specific implementation of the above embodiment, another approach for measuring the temperature of the wire rod is provided as a refinement and extension of the specific implementation of the above embodiment. As shown in FIG. 4, the method includes the following steps 301 to 308.

In step 301, an infrared thermal image of a wire rod whose temperature is to be measured is acquired in real time, and an effective temperature measurement area is determined based on the infrared thermal image and feature information of the wire rod.

In the above embodiment of the present disclosure, the infrared thermal image of the wire rod is obtained in real time, and the effective temperature measurement area is determined based on the infrared thermal image and the feature information of the wire rod. Dynamically capturing the effective temperature measurement area can improve the accuracy of temperature measurement.

In step 302, a geometric model of the wire rod whose temperature is to be measured is constructed, multiple light rays to be traced are constructed, a projection angle of each light ray to be traced and an intrinsic emissivity of the wire rod are determined. A light ray to be traced is projected onto a target projection point on the wire rod geometric model at such a projection angle that the light ray propagates toward the target projection point.

Optionally, the construction of the geometric model of the wire rod to be temperature measured in step 302 includes the following steps 302-1 to 302-2.

In step 302-1, geometric parameters of the wire rod to be temperature measured are acquired. The wire rod geometric parameters include spatial coordinate parameters of the wire rod along an X axis, a Y axis and a Z axis in a preset spatial coordinate system.

In step 302-2, based on the spatial coordinate parameters, the geometric model of the wire rod to be temperature measured is constructed in the preset spatial coordinate system.

In step 303, a light propagation path of a light ray which is being projected onto the wire rod geometric model is traced. The wire rod geometric model includes multiple target projection points.

In step 304, a random number is generated when the light ray to be traced is projected onto the target projection point on the wire rod geometric model. If the random number is greater than the intrinsic emissivity of the wire rod, it is determined that the light ray to be traced is reflected.

In step 305, if the random number is less than the intrinsic emissivity of the wire rod, it is determined that the light ray to be traced is absorbed.

In step 306, a local effective emissivity of the target projection point is calculated based on the number of absorbed light rays and the total number of light rays to be traced. The effective emissivity for the wire rod geometric model is obtained according to the local effective emissivities of multiple target projection points.

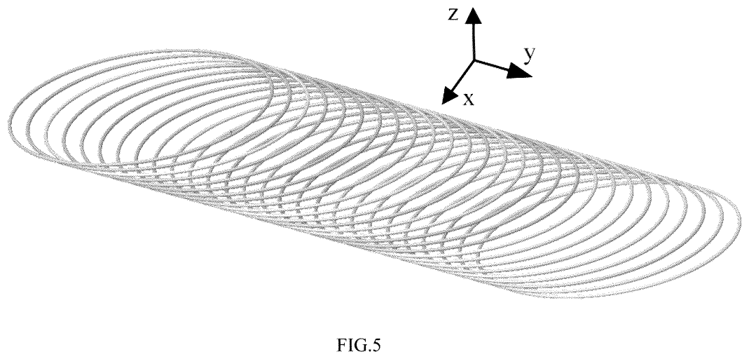

Next, the geometric model of the wire rod is constructed before calculating the effective emissivity of the wire rod. A three-dimensional wire rod surface model (i.e., the wire rod geometric model) is constructed based on the production site and actual parameters of the wire rod (including a coil diameter, a wire rod diameter, a roller speed, a rolling speed, etc.), as shown in FIG. 5. Then, the effective emissivity of the wire rod is calculated by the Monte Carlo method based on the constructed wire rod geometric model. Specifically, multiple light rays to be traced are constructed, and are projected onto target projection points on the wire rod geometric model respectively. A light propagation path of a light ray which is being projected onto the wire rod geometric model is traced. If the random number is greater than the intrinsic emissivity of the wire rod, the light ray to be traced is reflected. If the random number is less than the intrinsic emissivity of the wire rod, the light ray to be traced is absorbed. The local effective emissivity of the target projection point is calculated based on the number of absorbed light rays and the total number of light rays to be traced. The effective emissivity for the wire rod geometric model is obtained based on the local effective emissivities for the multiple target projection points.

In step 307, the temperature measurements in the effective temperature measurement area are filtered to obtain multiple peak temperatures after filtering.

In step 308, effective peak emissivities in multiple change cycles are determined according to a change cycle of the effective emissivity. The peak temperature interference deviation is calculated based on the differences between the effective peak emissivities and the intrinsic emissivity. The peak temperatures are corrected according to the peak temperature interference deviation to obtain the corrected temperature measurement result.

Next, the temperature measurements in the effective temperature measurement area are filtered to obtain multiple peak temperatures after filtering. According to the change cycle of the effective emissivity, the effective peak emissivities within multiple change cycles are determined. Based on the differences between the effective peak emissivities and the inherent emissivity, the peak temperature interference deviation is calculated. The peak temperatures are corrected according to the peak temperature interference deviation to obtain the corrected temperature measurement result. The large range of change in the effective emissivity will result in large fluctuations in the temperature measurement. The mesh structure of the wire rod makes its temperatures staggered. The peak filtering method can improve the stability and reliability of temperature measurement. The temperature filtering space and time can be selected according to the effective emissivity that changes periodically. Considering that the effective emissivity is periodic, the effective peak emissivity is also periodic and the peak temperature in each cycle is unique, the filtering space is reasonably selected to perform peak filtering on the temperature information. For the selection of the filtering space, the period of the effective emissivity, the width of the effective temperature measurement area, and the control requirements of the lateral temperature (perpendicular to the transmission direction) are comprehensively considered. For the selection of filtering time, the peak temperature should be captured under the non-uniform overlap, and also a certain amount of effective temperature information should be retained. To this end, the peak temperature in the effective temperature measurement area is corrected according to the effective peak emissivity. Since the effective temperature measurement area at the edge of the wire rod may be stacked with an overlap of 50-200 mm in thickness, this area is greatly affected by effective radiation. The temperature obtained by the thermal imager is based on the inherent emissivity of the wire rod. In order to obtain a more accurate temperature measurement result, the temperature measurement in this area is corrected. In view of fact that the effective peak emissivity in the same cycle is unique and there is a correspondence between the effective peak emissivity and the peak temperature in the same cycle, the peak temperature obtained after peak filtering in the effective temperature measurement area is corrected according to the differences between the effective peak emissivities and the inherent emissivity of the wire rod, thereby obtaining a relatively stable and accurate temperature measurement result.

In addition, based on accurate temperature measurement and temperature field measurement, the transverse temperature distribution curve of the wire rod can be obtained to guide the air volume configuration of the Optiflex and improve the uniformity of wire rod cooling. Furthermore, through the arrangement of multiple measuring points, the temperature curve of the wire rod during the entire cooling process can be obtained to control the cooling speed of the wire rod so as to obtain the preset product quality performance.

With the technical solution of this embodiment, after the temperature measurement system is installed according to the actual parameters of the production site, the infrared thermal image of the wire rod captured by the thermal imager is analyzed and processed by the image processing method, thereby dynamically capturing the effective temperature measurement area of the wire rod during the movement of the wire rod. In addition, reasonable filtering space and time are selected to perform peak filtering on the temperature measurement information of the wire rod and correct the peak temperature, and finally the temperature of the wire rod is obtained, which improves the accuracy and stability of temperature measurement.

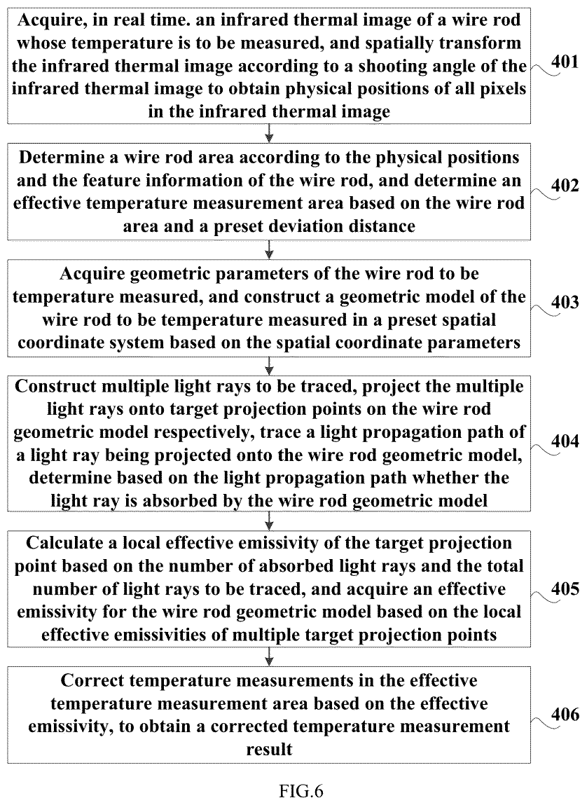

Furthermore, in order to fully illustrate the specific implementation of this embodiment, another method for measuring the temperature of the wire rod is provided, as a refinement and extension of the specific implementation of the above embodiment. As shown in FIG. 6, the method includes the following steps 401 to 406.

In step 401, an infrared thermal image of a wire rod whose temperature is to be measured is acquired in real time, and is spatially transformed according to a shooting angle of the infrared thermal image to obtain a physical position of each pixel in the infrared thermal image.

In step 402, a wire rod area is determined according to the physical positions and the feature information of the wire rod, and the effective temperature measurement area is determined based on the wire rod area and a preset deviation distance.

In the embodiment of the present disclosure, the infrared thermal image of the wire rod is acquired in real time, and the infrared thermal image is spatially transformed according to the shooting angle of the infrared thermal image. Specifically, the temperature measurement system is calibrated, the installation geometric parameters of the thermal imager are determined, the image is spatially transformed according to the principle of geometric transformation, the positional relationship between the pixels in the thermal image and the actual physical positions is established, and the physical position of each pixel in the infrared thermal image is obtained. Here, the pixels on the thermal image are traversed using the knowledge of image processing, the wire rod area is determined according to the physical position and the feature information of the wire rod, and the effective temperature measurement area is determined based on the wire rod area and the preset deviation distance. Dynamically capturing the effective temperature measurement area during the temperature measurement can improve the accuracy of temperature measurement.

In step 403, geometric parameters of the wire rod to be temperature measured are obtained, and a geometric model of the wire rod to be temperature measured is constructed in a preset spatial coordinate system based on the spatial coordinate parameters. The wire rod geometric parameters include spatial coordinate parameters of the wire rod along an X-axis, a Y-axis and a Z-axis in the preset spatial coordinate system.

Next, the geometric parameters of the wire rod to be temperature measured are obtained. The wire rod geometric parameters include the spatial coordinate parameters of the wire rod along the X-axis, the Y-axis and the Z-axis in the preset spatial coordinate system. Based on the spatial coordinate parameters, the geometric model of the wire rod to be temperature measured is constructed in the preset spatial coordinate system (as shown in FIG. 5). The effective emissivity is calculated according to the constructed wire rod geometric model, and then the measured temperatures are corrected according to the effective emissivity.

In step 404, multiple rays to be traced are constructed, and are projected onto target projection points on the wire rod geometric model respectively. A light propagation path of a light ray being projected onto the wire rod geometric model is traced. It is determined based on the light propagation path whether the light ray is absorbed by the wire rod geometric model. The wire rod geometric model includes multiple target projection points.

In step 405, a local effective emissivity of the target projection point is calculated based on the number of absorbed light rays and the total number of light rays to be traced. The effective emissivity for the wire rod geometric model is obtained based on the local effective emissivities of multiple target projection points.

Next, multiple rays to be traced are constructed, and are projected onto target projection points on the wire rod geometric model respectively. A light propagation path of a light ray being projected onto the wire rod geometric model is traced. It is determined based on the light propagation path whether the light ray is absorbed by the wire rod geometric model. A local effective emissivity of the target projection point is calculated based on the number of absorbed light rays and the total number of light rays to be traced. The effective emissivity for the wire rod geometric model is obtained based on the local effective emissivities of multiple target projection points.

In step 406, the temperature measurements in the effective temperature measurement area are corrected based on the effective emissivity, to obtain a corrected temperature measurement result.

Next, the temperature measurements in the effective temperature measurement area are corrected based on the effective emissivity, to obtain the corrected temperature measurement result.

In a specific example, the temperature of a random complete wire rod with a wire diameter of 16 mm at the production site was measured separately with the embodiment of the present disclosure and a scanning pyrometer. The temperature measured by the embodiment of the present disclosure fluctuates by 13° C., while the temperature measured by the scanning pyrometer fluctuates by as much as 27° C. In addition, the standard deviations regarding the scanning pyrometer and the method of the embodiment of the present disclosure are 7.64° C. and 2.80° C., respectively. Therefore, the embodiments of the present disclosure significantly improve the stability of temperature measurement. The accuracy of the corrected temperature measurement of the wire rod can be improved by 15˜20° C. The temperature of a complete wire rod with a wire diameter of 16 mm is measured by the method of the embodiment of the present disclosure, and the temperature measurement data is processed by the processing method of the present disclosure to obtain the temperature distribution curve of the cross section of the wire rod. It is determined based on the distribution curve that the temperature at the overlap on both sides of the wire rod is higher than the temperature of the middle of the wire rod. Therefore, the Optiflex under the roller can be reasonably adjusted to regulate the air volume of each part to achieve uniform cooling of the wire rod.

With the technical solution of this embodiment, the infrared thermal image of the wire rod whose temperature is to be measured is acquired in real time, and is spatially transformed according to a shooting angle of the infrared thermal image to determine the wire rod area, and the effective temperature measurement area is determined based on the wire rod area and the preset deviation distance. The geometric parameters of the wire rod to be temperature measured are obtained, and the geometric model of the wire rod to be temperature measured is constructed in a preset spatial coordinate system based on the spatial coordinate parameters. Multiple rays to be traced are constructed, and are projected onto target projection points on the wire rod geometric model respectively. A light propagation path of a light ray being projected onto the wire rod geometric model is traced. It is determined based on the light propagation path whether the light ray is absorbed by the wire rod geometric model. A local effective emissivity of the target projection point is calculated based on the number of absorbed light rays and the total number of light rays to be traced. The effective emissivity for the wire rod geometric model is obtained based on the local effective emissivities of multiple target projection points. The temperature measurements in the effective temperature measurement area are corrected based on the effective emissivity to obtain the corrected temperature measurement result, thereby improving the accuracy of the temperature measurement.

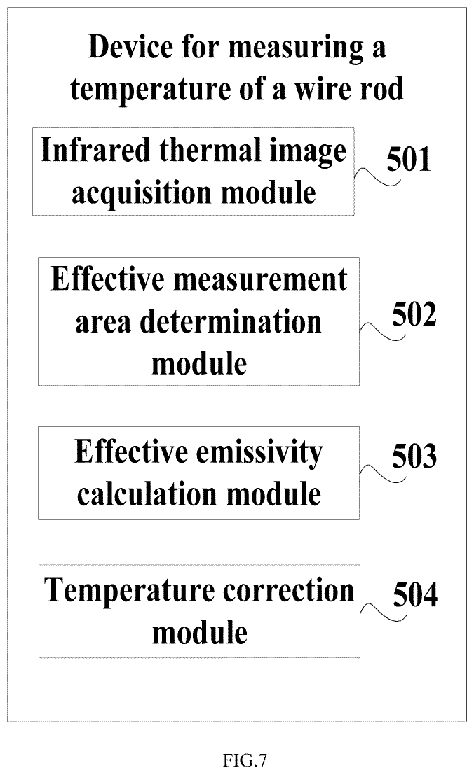

Furthermore, a device for measuring a temperature of a wire rod is provided according to an embodiment of the present disclosure, as a specific implementation of the method shown in FIG. 1. As shown in FIG. 7, the device includes an infrared thermal image acquisition module 501, an effective measurement area determination module 502, an effective emissivity calculation module 503, and a temperature correction module 504.

The infrared thermal image acquisition module 501 is configured to acquire, in real time, an infrared thermal image of the wire rod whose temperature is to be measured.

The effective measurement area determination module 502 is configured to determine an effective temperature measurement area according to the infrared thermal image and feature information of the wire rod.

The effective emissivity calculation module 503 is configured to construct a geometric model of the wire rod to be temperature measured; project preset light onto the wire rod geometric model, trace a light propagation path of the preset light, and calculate an effective emissivity based on a tracing result of the light propagation path.

The temperature correction module 504 is configured to correct temperature measurements in the effective temperature measurement area based on the effective emissivity to obtain a corrected temperature measurement result.

Optionally, the effective emissivity calculation module 503 is further configured to: construct multiple light rays to be traced, and project the light rays to be traced onto target projection points on the wire rod geometric model respectively, where the wire rod geometric model includes multiple target projection points; trace a light propagation path of the light ray that is being projected onto the wire rod geometric model, and determine according to the light propagation path whether the light ray to be traced is absorbed by the wire rod geometric model; and calculate a local effective emissivity of the target projection point according to the number of absorbed light rays and the total number of light rays to be traced, and acquire the effective emissivity for the wire rod geometric model according to the local effective emissivities for the multiple target projection points.

Optionally, the effective emissivity calculation module 503 is further configured to: determine a projection angle of each light ray to be traced and an intrinsic emissivity of the wire rod; and for a light ray to be traced, project the light ray to be traced onto the target projection point on the wire rod geometric model at such a projection angle that the light ray to be traced propagates toward the target projection point.

Optionally, the effective emissivity calculation module 503 is further configured to: generate a random number when the light ray to be traced is projected onto the target projection point of the wire rod geometric model; determine that the light ray to be traced is reflected if the random number is greater than the intrinsic emissivity of the wire rod; and determine that the light ray to be traced is absorbed if the random number is less than the intrinsic emissivity of the wire rod.

Optionally, the temperature correction module 504 is further configured to: filter the temperature measurements in the effective temperature measurement area to obtain multiple peak temperatures after filtering; and determine effective peak emissivities in multiple change cycles according to a change cycle of the effective emissivity, calculate a peak temperature interference deviation based on differences between the effective peak emissivities and the intrinsic emissivity, and correct the peak temperatures according to the peak temperature interference deviation to obtain the corrected temperature measurement result.

Optionally, the effective measurement area determination module 502 is further configured to: perform spatial transformation on the infrared thermal image according to a shooting angle of the infrared thermal image to obtain physical positions of all pixels in the infrared thermal image; and determine a wire rod area based on the physical positions and the feature information of the wire rod, and determine the effective temperature measurement area based on the wire rod area and a preset deviation distance.

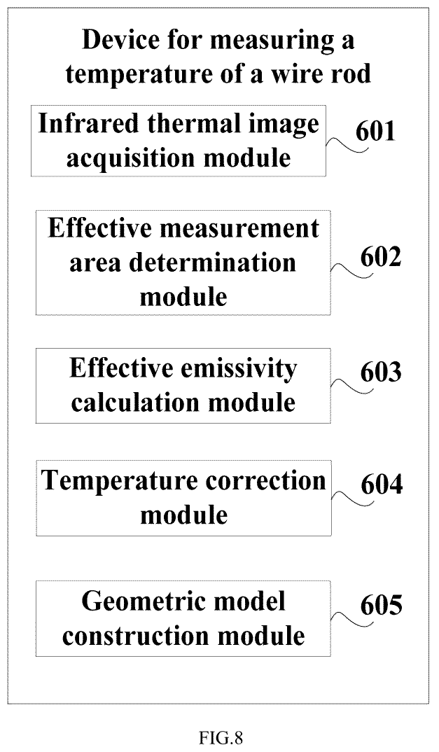

Furthermore, another device for measuring a temperature of a wire rod is further provided according to an embodiment of the present disclosure. As shown in FIG. 8, the device includes: an infrared thermal image acquisition module 601, an effective measurement area determination module 602, an effective emissivity calculation module 603, a temperature correction module 604, and a geometric model construction module 605.

The infrared thermal image acquisition module 601 is configured to acquire, in real time, an infrared thermal image of the wire rod whose temperature is to be measured.

The effective measurement area determination module 602 is configured to determine an effective temperature measurement area according to the infrared thermal image and feature information of the wire rod.

The effective emissivity calculation module 603 is configured to construct a geometric model of the wire rod to be temperature measured; project preset light onto the wire rod geometric model, trace a light propagation path of the preset light, and calculate an effective emissivity based on a tracing result of the light propagation path.

The temperature correction module 604 is configured to correct temperature measurements in the effective temperature measurement area based on the effective emissivity to obtain a corrected temperature measurement result.

The geometric model construction module 605 is configured to acquire geometric parameters of the wire rod to be temperature measured, where the wire rod geometric parameters include coordinate parameters of the wire rod along an X-axis, a Y-axis and a Z-axis in a preset spatial coordinate system; and construct the wire rod geometric model of the wire rod in the preset spatial coordinate system based on the spatial coordinate parameters.

Optionally, the effective emissivity calculation module 603 is further configured to: construct multiple light rays to be traced, and project the light rays to be traced onto target projection points on the wire rod geometric model respectively, where the wire rod geometric model includes multiple target projection points; trace a light propagation path of the light ray that is being projected onto the wire rod geometric model, and determine according to the light propagation path whether the light ray to be traced is absorbed by the wire rod geometric model; and calculate a local effective emissivity of the target projection point according to the number of absorbed light rays and the total number of light rays to be traced, and acquire the effective emissivity for the wire rod geometric model according to the local effective emissivities for the multiple target projection points.

Optionally, the effective emissivity calculation module 603 is further configured to: determine a projection angle of each light ray to be traced and an intrinsic emissivity of the wire rod; and for a light ray to be traced, project the light ray to be traced onto the target projection point on the wire rod geometric model at such a projection angle that the light ray to be traced propagates toward the target projection point.

Optionally, the effective emissivity calculation module 603 is further configured to: generate a random number when the light ray to be traced is projected onto the target projection point of the wire rod geometric model; determine that the light ray to be traced is reflected if the random number is greater than the intrinsic emissivity of the wire rod; and determine that the light ray to be traced is absorbed if the random number is less than the intrinsic emissivity of the wire rod.

Optionally, the temperature correction module 604 is further configured to: filter the temperature measurements in the effective temperature measurement area to obtain multiple peak temperatures after filtering; and determine effective peak emissivities in multiple change cycles according to a change cycle of the effective emissivity, calculate a peak temperature interference deviation based on differences between the effective peak emissivities and the intrinsic emissivity, and correct the peak temperatures according to the peak temperature interference deviation to obtain the corrected temperature measurement result.

Optionally, the effective measurement area determination module 602 is further configured to: perform spatial transformation on the infrared thermal image according to a shooting angle of the infrared thermal image to obtain physical positions of all pixels in the infrared thermal image; and determine a wire rod area based on the physical positions and the feature information of the wire rod, and determine the effective temperature measurement area based on the wire rod area and a preset deviation distance.

It should be noted that for other corresponding descriptions of the functional units involved in the device for measuring a temperature of a wire rod provided in the embodiments of the present disclosure, reference can be made to the corresponding descriptions in the method shown in FIGS. 1, 4 and 6, and therefore the functional units are described in brief herein.

Based on the above method as shown in FIGS. 1, 4 and 6, a storage medium, on which a computer program is stored, is accordingly provided according to an embodiment of the present disclosure. When the computer program is executed by a processor, the method for measuring a temperature of a wire rod as shown in FIGS. 1, 4 and 6 is implemented.

Based on this understanding, the technical solution of the present disclosure may be embodied in the form of a software product. The software product may be stored in a non-volatile storage medium (which may be a CD-ROM, a USB flash drive, a mobile hard disk, etc.), and includes a number of instructions for instructing a computer device (like a personal computer, a server, or a network device, etc.) to execute the method described in each implementation scenario of the present disclosure.

Based on the above method as shown in FIG. 1, FIG. 4 and FIG. 6, and the virtual device embodiments as shown in FIG. 7 and FIG. 8, a computer device is also provided according to an embodiment of the present disclosure in order to achieve the above objectives. The computer device may be a personal computer, a server, a network device, etc. The computer device includes a storage medium and a processor. The storage medium is configured to store a computer program. The processor is configured to execute the computer program to implement the above method for measuring a temperature of the wire rod as shown in FIG. 1, FIG. 4 and FIG. 6.

Optionally, the computer device may also include a user interface, a network interface, a camera, a radio frequency (RF) circuit, a sensor, an audio circuit, a WI-FI module, etc. The user interface may include a display, an input unit such as a keyboard, etc. The optional user interface may also include a USB interface, a card reader interface, etc. The network interface may optionally include a standard wired interface, a wireless interface (such as a Bluetooth interface, a WI-FI interface), etc.

Those skilled in the art should appreciate that the structure of the computer device provided in this embodiment does not constitute a limitation on the computer device. Instead, the computer device may include more or fewer components, or a combination of certain components, or different component arrangements.

The storage medium may also include an operating system and a network communication module. The operating system is a program that manages and saves the hardware and software resources of the computer device, and supports the operation of information processing programs and other software and/or programs. The network communication module is to realize the communication between the components inside the storage medium, and the communication with other hardware and software in the physical device.

Through the description of the above embodiments, those skilled in the art can clearly understand that the present disclosure can be implemented by means of software plus a necessary general hardware platform, or by hardware. According to the present disclosure, a method and a device for measuring a temperature of a wire rod, a storage medium, and a computer device are disclosed. The method includes: acquiring, in real time, an infrared thermal image of the wire rod whose temperature is to be measured; determining an effective temperature measurement area according to the infrared thermal image and feature information of the wire rod; constructing a geometric model of the wire rod to be temperature measured, projecting preset light onto the wire rod geometric model, tracing a light propagation path of the preset light, and calculating an effective emissivity based on a tracing result of the light propagation path; and correcting temperature measurements in the effective temperature measurement area based on the effective emissivity to obtain a corrected temperature measurement result. The infrared thermal image is acquired, and is analyzed by image processing, thereby dynamically capturing the effective temperature measurement area. The effective emissivity between wire rods is calculated, and then the measured temperature of the wire rod is corrected, thereby improving the accuracy and stability of temperature measurement on wire rods.

Those skilled in the art should understand that the drawings are only schematic diagrams of preferred implementation scenarios, and the modules or processes in the accompanying drawings are not necessarily essential for implementing the present disclosure. Those skilled in the art should understand that the modules in the device in the implementation scenarios may be distributed in the device of the implementation scenario according to the description of the implementation scenario, or may be changed accordingly and located in one or more devices different from the present implementation scenario. The modules of the above implementation scenarios may be combined into one module, or may be further split into multiple sub-modules.

The serial numbers in this application are only for description and do not represent the advantages and disadvantages of the implementation scenarios. The foregoing discloses only a few specific implementation scenarios of the present disclosure. However, the present disclosure is not limited thereto, and any changes that can be thought of by a person skilled in the art should fall within the scope of protection of the present disclosure.

What is claimed is:

1. A method for measuring a temperature of a wire rod, wherein the method comprises:
acquiring, in real time, an infrared thermal image of the wire rod whose temperature is to be measured;
determining an effective temperature measurement area according to the infrared thermal image and feature information of the wire rod;
constructing a geometric model of the wire rod to be temperature measured, projecting preset light onto the wire rod geometric model, tracing a light propagation path of the preset light, and calculating an effective emissivity based on a tracing result of the light propagation path; and
correcting temperature measurements in the effective temperature measurement area based on the effective emissivity to obtain a corrected temperature measurement result.

2. The method according to claim 1, wherein the correcting temperature measurements in the effective temperature measurement area based on the effective emissivity to obtain a corrected temperature measurement result comprises:
filtering the temperature measurements in the effective temperature measurement area to obtain a plurality of peak temperatures after filtering; and
determining effective peak emissivities in a plurality of change cycles according to a change cycle of the effective emissivity, calculating a peak temperature interference deviation based on differences between the effective peak emissivities and an intrinsic emissivity, and correcting the peak temperatures according to the peak temperature interference deviation to obtain the corrected temperature measurement result.

3. The method according to claim 1, wherein the determining an effective temperature measurement area according to the infrared thermal image and feature information of the wire rod comprises:
performing spatial transformation on the infrared thermal image according to a shooting angle of the infrared thermal image to obtain physical positions of all pixels in the infrared thermal image; and
determining a wire rod area based on the physical positions and the feature information of the wire rod, and determining the effective temperature measurement area based on the wire rod area and a preset deviation distance.

4. The method according to claim 1, wherein the constructing a geometric model of the wire rod to be temperature measured comprises:
acquiring geometric parameters of the wire rod to be temperature measured, wherein the wire rod geometric parameters comprise spatial coordinate parameters of the wire rod along an X-axis, a Y-axis and a Z-axis in a preset spatial coordinate system; and
constructing the geometric model of the wire rod to be temperature measured in the preset spatial coordinate system based on the spatial coordinate parameters.

5. A device for measuring a temperature of a wire rod, wherein the device comprises:
an infrared thermal image acquisition module for acquiring, in real time, an infrared thermal image of the wire rod whose temperature is to be measured;
an effective measurement area determination module for determining an effective temperature measurement area according to the infrared thermal image and feature information of the wire rod;
a geometric model construction module for constructing a geometric model of the wire rod to be temperature measured;
an effective emissivity calculation module for projecting preset light onto the wire rod geometric model, tracing a light propagation path of the preset light, and calculating an effective emissivity based on a tracing result of the light propagation path; and
a temperature correction module for correcting temperature measurements in the effective temperature measurement area based on the effective emissivity to obtain a corrected temperature measurement result.

6. A storage medium having a computer program stored thereon, wherein the computer program, when executed by a processor, implements the method for measuring a temperature of a wire rod according to claim 1.

7. A computer device, comprising a storage medium, a processor, and a computer program stored on the storage medium and executable by the processor, wherein the processor, when executing the computer program, implements the method for measuring a temperature of a wire rod according to claim 1.
